(19) United States
(12) Patent Application Publication
(10) Pub. No.: US 2002/0122893 A1
(43) Pub. Date: Sep. 5, 2002

(54) Dual spindle paint roller

(76) Inventor: Thomas J. Tramont, West Hartford, CT (US)

Correspondence Address: ALIX YALE & RISTAS LLP, 750 MAIN STREET, SUITE 1400, HARTFORD, CT, 06103, US

(21) Appl. No.: 09/798,369

(22) Filed: Mar. 2, 2001

(51) Int. Cl. B05C 17/02; B05D 1/28; B05D 5/00

(52) U.S. Cl. 427/428; 15/230.11; 492/13; 492/19; 427/262; 427/267

(57) ABSTRACT

A paint roller assembly is provided comprising a handle, first and second arms supported by the handle, a substantially cylindrical first paint roller rotatably supported by the first arm and a substantially cylindrical second roller rotatably supported by the second arm, whereby the two rollers are spaced from each other such that the first roller can rotate without contacting the second roller. Using this and similar paint roller assemblies, the painter can implement the method embodiment of the invention, by dipping only the first roller in a supply of paint and then contacting the wall with the first roller to apply paint to a region of the wall. The first roller is then removed from the wall and the painter rotates the assembly to position the second roller at the wall whereupon only the second roller is rolled over at least a portion of the region previously painted with the first roller. Thereafter, the painter withdraws the paint assembly from the wall, rotates the assembly and dips only the first roller in the supply of paint, whereupon the foregoing method steps are repeated for successively different regions of the wall.

### BACKGROUND OF THE INVENTION

The present invention relates to paint roller equipment, and in particular, to a paint roller of the type commonly used for applying special effects to large walls or the like.

U.S. Pat. No. 5,693,141 entitled “Special Effects Paint Roller” describes a paint roller which can produce so-called “faux”0 effects when painting a wall, ceiling, or other large surfaces of a room or the like. One method is known as the “positive” mode, which is essentially applying paint. This method is achieved by creating various patterns of paint with an irregular porous material which will hold paint, such as a sea sponge. This method leaves definite painted and non-painted areas. Paint rollers using similar materials may also be used to apply paint in various patterns to create the “faux” effect. The other method is known as the “negative mode”, which essentially manipulates wet paint by pushing, smearing or embossing a wet paint surface, with a generally non-porous material such as plastic. This method leaves random areas of relatively high and relatively low paint density. With this method the entire surface is covered with paint, using a conventional roller or paint brush to apply paint to one small area at a time and then quickly, before the paint dries, manipulating the paint by pushing, smearing and embossing the paint with a relatively non-porous material or paint roller, covered with such a material.

The present invention relates to the “negative mode” of producing a “faux” effect. The conventional “negative mode” procedure is labor intensive and physically exhausting because this procedure requires the painter to employ two different paint rollers. The first is used in a conventional manner by dipping the roller in a tray on the floor or other support surface, placing that roller against a region of the wall and reciprocating the roller until the region is covered with a base color paint, returning the first roller to the tray, picking up a second roller which has a predominantly non-porous surface, and applying that roller against the previously painted region before it dries That roller is then brought back to its own tray, whereupon the other, first roller is picked up, dipped, and another region of the wall is painted with the base color. Each region must be started quickly before the edge of the previously completed dries, to avoid overlap lines between regions. This procedure is repeated many times until the wall has been fully covered with the faux effect.

The present inventor has recognized that this conventional process is quite inefficient in the requirement for picking up a first roller, laying it down before picking up the other roller, with the associated back and forth movements between the region to be painted and the respective trays and the requirement that the paint does not dry before the process is complete and before the previous region is dry.

### SUMMARY OF THE INVENTION

It is, accordingly, an object of the invention to provide an improved paint roller tool, paint roller assembly, and painting method, whereby the painter can first apply paint to a region of the wall and thereafter produce the faux effect by using a different roller, while remaining in the painting position and without return to a tray.

In particular, a paint roller assembly is provided comprising a handle, first and second arms supported by the handle, a substantially cylindrical first paint roller rotatably supported by the first arm and a substantially cylindrical second roller rotatably supported on a different rotation axis by the second arm, whereby the two rollers are spaced from each other such that the first roller can rotate without contacting the second roller.

Using this and similar paint roller assemblies, the painter can implement the method embodiment of the invention, by dipping only the first roller in a supply of paint and then contacting the wall with the first roller to apply paint to a region of the wall. The first roller is then removed from the wall and the painter rotates the assembly to position the second roller at the wall whereupon only the second roller is rolled over at least a portion of the region previously painted with the first roller. Thereafter, the painter withdraws the paint assembly from the wall, rotates the assembly and dips only the first roller in the supply of paint, whereupon the foregoing method steps are repeated for successively different regions of the wall.

The invention also encompasses a paint roller tool having a handle defining a tool centerline, first and second arms supported by the handle and having respective first and second end portions spaced laterally from and extending generally parallel to the centerline. A substantially cylindrical first spindle is rotatably supported by the end of the first arm and extends along a first rotation axis that is perpendicular to the centerline. A substantially cylindrical second spindle is rotatably supported by the end of the second arm and extends along a second rotation axis that is perpendicular to the centerline. These spindles are adapted to receive thereover a substantially cylindrical paint roller, in a conventional manner.

### BRIEF DESCRIPTION OF THE DRAWINGS

The preferred embodiments of the invention will be described in greater detail below with reference to the accompany drawings, in which:

FIG. 1 is a side view of a first embodiment of the invention;

FIG. 2 is an end view of the first embodiment, taken from the left as depicted in FIG. 1;

FIG. 3 is a schematic representation of the first embodiment during use in painting a wall; and

FIG. 4 is a top view, of a second embodiment, with one arm partially deleted for clarity.

### DESCRIPTION OF THE PREFERRED EMBODIMENT

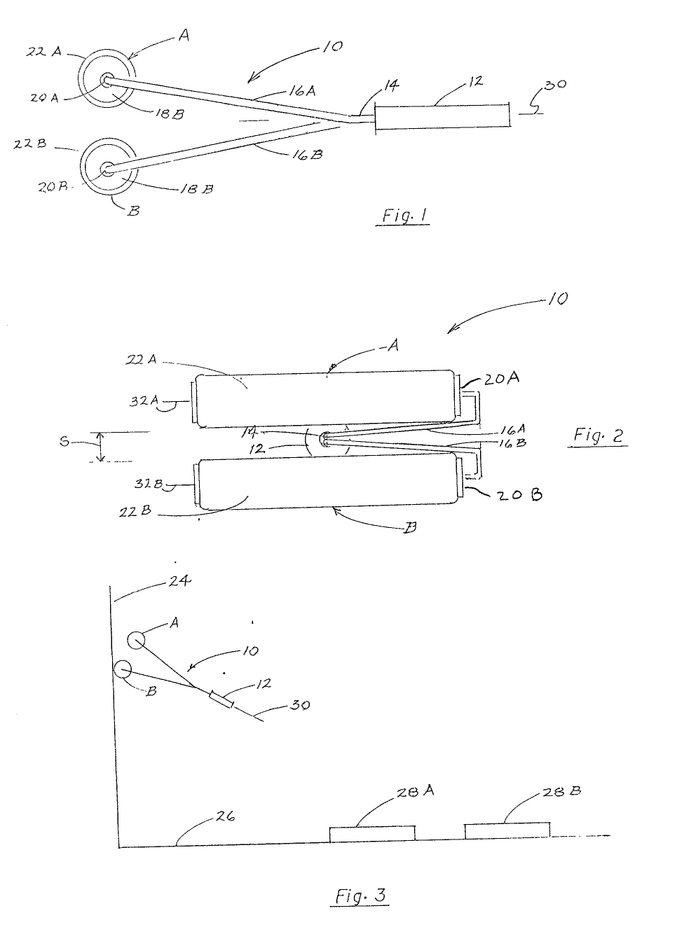

FIGS. 1 and 2 depict a first embodiment of a paint roller assembly 10, having a generally elongated, cylindrical handle 12, a shank portion 14, and first and second arms 16A, 16B which in essence are supported by the handle and have respective first and second end portions 20A, 20B. The arms 16A, 16B extend in a direction generally along or parallel to the centerline 30 of the handle and roller assembly, although exact parallelism relative to the centerline is not required, so long as the ends 20A, 20B of the arms are spaced in fixed relation at a reasonable working distance from the handle 12. The ends 20A, 20B are configured to support hubs or spindles around which respective roller cores 18A, 18B with associated outer surfaces 22A, 22B are slip fit, in a conventional manner.

The first roller A and the second roller B, are shown as spaced apart from each other such that the distance S between the confronting surfaces of the rollers is at least about 20% of the perpendicular distance between the rotation axis 32A of the first roller and the rotation axis 32B of the second roller. It can be appreciated from FIGS. 1 and 2, that the rotation axes 32A, 32B of the rollers are perpendicular to the centerline 30 but not coaxial with each other, and the centerline 30 and axes 32A, 33A, are not all coplanar.

For purposes of producing the faux effect as described in the Background, the outer surface 22A of roller A can be understood as made from a material which is predominantly porous, so that it will absorb paint and have a texture and resiliency such that the paint can be transferred to the wall in a controllable thickness resulting in part from the force applied by the painter when rolling that roller A along the wall. In contrast, roller B would typically have an outer surface 22B constituted primarily by non-porous material which, even when covered with paint, would tend to push or smear the paint, rather than apply it in a substantially uniform thickness.

The method of the present invention, can be understood with reference with FIG. 3. The painter (not shown) would hold the paint roller assembly 10 by the handle 12 at an oblique angle of the centerline 30 relative to the (typically) vertical wall 24 which is to be painted. The process can be described with any starting point, but for convenience, roller A, having the porous surface, is dipped in a tray 28A having a base color paint and roller A is urged against the wall such that the end is rolled over the wall to apply paint to a region of the wall. When the paint carried by roller A is insufficient to provide good coverage, the painter pulls the assembly 10 away from the wall and while standing on the floor 26 at substantially the same location, rotates the handle 12 so that roller B is juxtaposed with the wall and, after contacting the wall with roller B as shown in FIG. 3, the painter rolls the second roller over a portion, and typically all of, the region previously painted with roller A. When the painter is satisfied with the faux effect as thereby produced, the roller assembly is pulled away from the wall and rotated again such that roller A is closer to the floor 26 and thereby can be dipped into the paint tray 28A, whereupon the foregoing steps are repeated until the faux effect on the entire wall has been completed.

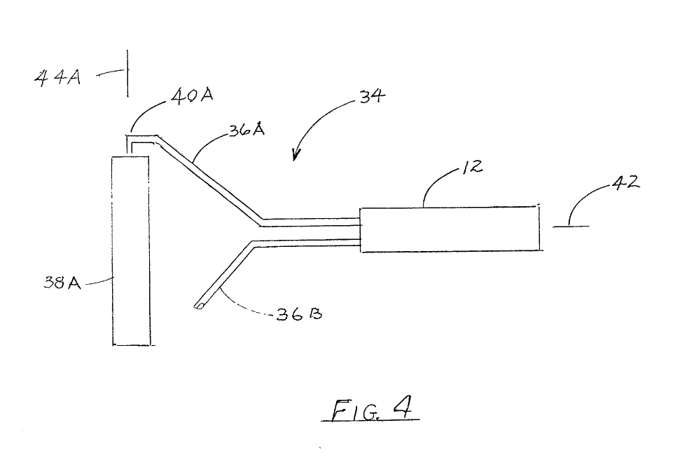

FIG. 4 depicts a second embodiment as seen from the top, without the rollers in place. In this embodiment 34, the handle 12 and associated tool centerline 42 are similar to those shown with respect to FIG. 1. However, instead of a shank or stem, in this embodiment, arms 36A and 36B are separate from each other at their attachment to the handle 12 and diverge from the centerline 42 not only laterally in the plane of the paper, but also laterally with, for example, arm 36A rising out of the plane of the paper and arm 36B dropping below the plane of the paper. At the end of arm 36A, a standard attachment 40A for a roller spindle 38A is provided, whereby the spindle 38A can rotate about axis 44. The end of arm 36B has similar attachment for a spindle to rotate about a respective rotation axis, but these would be directly below the arm end 40A and spindle 38A and axis 44A, and therefore not explicitly shown in FIG. 4. Thus, in the embodiments of FIGS. 1 and 4, the rotation axes 32A and 32B lie in a plane which is perpendicular to centerline 30, and axes 44A and 44B lie in a plane which is perpendicular to centerline 42.

It should therefore be understood that an important aspect of the present invention is the arrangement of two spindles/rollers relative to a handle, which are spaced apart such that they can conveniently and easily be used in alternation, rather than simultaneously. This is in distinction with known arrangements whereby two rollers contact each other such that one of the rollers serves as a supply to transfer paint to the other roller which then transfers paint to the target surface. Similarly, the present invention is distinguishable from known arrangements whereby two rollers connected to a single handle, can apply paint simultaneously to a wall.

1. A paint roller assembly comprising:
a handle defining an assembly center line;
first and second arms supported by the handle and having respective first and second end portions;
a substantially cylindrical first paint roller rotatably supported by the end of the first arm and extending along a first rotation axis that is perpendicular to the centerline;
a substantially cylindrical second roller rotatably supported by the end of the second arm and extending along a second rotation axis that is perpendicular to the centerline but not coaxial with the first rotation axis;
wherein the second roller is spaced from the first roller such that the first roller can rotate without contacting the second roller.

2. The paint roller assembly of claim 1, wherein each of the rollers has an outer surface and
the outer surface of the first roller is predominantly porous material; and
the outer surface of the second roller is predominantly non-porous material.

3. The paint roller assembly of claim 1, wherein the rollers have confronting outer surfaces and the outer surfaces are spaced apart by a distance which exceeds about 20 per cent of the perpendicular distance between the first and second rotation axes.

4. The paint roller assembly of claim 1, wherein the first and second rotation axes lie in a plane that is perpendicular to the centerline.

5. A paint roller tool comprising:
a handle defining a tool center line;
first and second arms supported by the handle and having respective first and second end portions spaced laterally from and extending generally along the centerline;
a substantially cylindrical first spindle rotatably supported by the end of the first arm and extending along a first rotation axis that is perpendicular to the centerline, said first spindle adapted to receive thereover a substantially cylindrical paint roller;
a substantially cylindrical second spindle rotatably supported by the end of the second arm and extending along a second rotation axis that is perpendicular to the centerline, said second spindle adapted to receive thereover a substantially cylindrical paint roller.

6. A method for painting a faux effect on a wall or the like using a paint roller assembly including a handle defining an assembly center line; first and second arms supported by the handle and having respective first and second end portions spaced laterally from and extending generally along the centerline; a substantially cylindrical first paint roller rotatably supported by the end of the first arm and extending along a first rotation axis that is perpendicular to the centerline; a substantially cylindrical second roller rotatably supported by the end of the second arm and extending along a second rotation axis that is perpendicular to the centerline; wherein the second roller is spaced from the first roller such that the first roller can rotate without contacting the second roller, comprising:
(A) dipping only the first roller in a first supply of paint;
(B) contacting the wall with the first roller such that the assembly centerline is at an oblique angle relative to the wall;
(C) rolling the roller over the wall to apply paint to a region of the wall;
(D) removing the first roller from the wall;
(E) rotating the assembly about the assembly axis and contacting said region of the wall with only the second roller;
(F) rolling the second roller over at least a portion of said region;
(G) rotating the assembly again about the assembly axis; and
(H) repeating steps (A) through (G) for successively different regions of the wall.

7. The method of claim 6, wherein in step (E), the second roller is dipped in a second supply of paint after said rotation but before contacting said region of the wall.

8. The method of claim 6, wherein
the first roller has a predominantly porous outer surface that absorbs paint and transfers paint to the wall when rolled thereon;
the second roller has a predominantly nonporous surface that when rolled in the region, smears and embosses the paint previously applied by the first roller before the paint dries.
